(19) United States
(12) Patent Application Publication
(10) Pub. No.: US 2010/0230389 A1
(43) Pub. Date: Sep. 16, 2010

(54) WAVEFORM CONTROL IN DRAWN ARC FASTENER WELDING

(75) Inventors: Christopher Hsu, Avon, OH (US); Jeffrey J. Krupp, Vermillion, OH (US)

Correspondence Address: GIFFORD, KRASS, SPRINKLE,ANDERSON & CITKOWSKI, P.C, PO BOX 7021, TROY, MI, 48007-7021, US

(73) Assignee: Nelson Stud Welding, Inc., Elyria, OH (US)

(21) Appl. No.: 12/560,538

(22) Filed: Sep. 16, 2009

Related U.S. Application Data
(60) Provisional application No. 61/097,351, filed on Sep. 16, 2008.

(51) Int. Cl. B23K 9/16; B23K 9/10

(52) U.S. Cl. 219/74; 219/130.1

(57) ABSTRACT

A drawn arc welding process that includes the steps of a) providing a welding device having a fastener, b) providing a power supply and controller linked with the welding tool, c) providing a work piece, d) energizing a main welding current in the welding tool locally melting the workpiece and forming a weld pool, e) changing the energizing current to a predetermined plunge current, and f) plunging the fastener into the locally melted workpiece at the predetermined plunge current forming a weld between the fastener and the work piece.

### CROSS-REFERENCE TO RELATED APPLICATIONS

This application claims priority benefit of U.S. provisional patent application No. 61/097,351 filed on Sep. 16, 2008 and is herein incorporated by reference.

### FIELD OF THE INVENTION

The invention relates to stud welding processes.

### BACKGROUND OF THE INVENTION

Generally, drawn arc stud welding may use a welding current that is supplied by a power supply and may be controlled and regulated. In the prior art of drawn arc stud welding, at the end of a main current arc, the power supply turns off the welding device such that the output of the arc is allowed to current decay to a zero value. The welding device is then commanded to plunge a stud into a molten pool at the end of the main arc. The actual current when the stud touches the weld pool during the plunge may have an effect on the quality of the weld produced. For example, when the current is too high excessive weld spatter may be generated. However, when the current is too low the weld pool may be cooled off and a cold weld is produced such that a stud will not be satisfactorily welded to a workpiece. In prior art applications, in order to avoid a cold weld, a delay is often needed to extend the main arc time beyond what is required to form the weld pool such that the stud may be adequately attached to a workpiece. Programming this delay or synchronizing the current delay and stud plunge movement is difficult and often the source of guesswork or trial and error. As stated above, an insufficient delay would cause the weld current to turn off too soon resulting in a cold weld, while a delay of an excessive time would cause excessive spatter and form additional heat in cables and connectors associated with the welding device.

There is therefore a need in the art for a drawn arc stud welding process that solves the problems of cold plunge, adjusting a delay, and removing excessive heat from cables associated with a welding device. There is also a need in the art for a drawn arc welding process that is easily implemented in a welding gun system such that a user may produce quality welds with ease and without extensive training and trial-and-error adjustment of the welding parameters or welding device. There is also a need in the art for a more forgiving process that produces good weld quality despite the wear and lubrication maintenance of gun components that can affect the actual plunge behavior. Further, there is a need in the art for a drawn arc welding process that utilizes less energy in comparison to prior art devices and processes.

### SUMMARY OF THE INVENTION

In one aspect there is disclosed a process for drawn arc welding including the steps of: a) providing a welding device having a fastener, b) providing a power supply and controller linked with the welding tool, c) providing a work piece, d) energizing a main welding current in the welding tool locally melting the workpiece and forming a weld pool, e) lowering the energizing current to a predetermined plunge current, and f) plunging the fastener into the locally melted workpiece at the predetermined plunge current forming a weld between the fastener and the work piece.

In another aspect there is disclosed a process for drawn arc welding including the steps of: a) providing a welding tool having a fastener; b) providing a power supply and controller linked with the welding tool; c) providing a workpiece; d) measuring the actual plunge time of the welding tool including: lifting and plunging the fastener toward the work piece and starting a timer; detecting the contact of the fastener and the workpiece and stopping the timer; and recording the time between the start and stop of the timer; e) lifting the fastener and energizing a pilot arc, and energizing a main welding current in the welding tool for a time defined by a preprogrammed value locally melting the end of the fastener and the workpiece and forming a weld pool; and f) plunging the fastener into the locally melted workpiece and controlling the power supply current to a plunge current level, and maintain that current for a time determined by the timer value in step d) plus additional time to ensure the contact of the fastener and the workpiece occurs before the plunge current is turned off; and g) turn off the plunge current and withdraw the welding tool from the welded fastener.

In another aspect there is disclosed a process for drawn arc welding including the steps of: a) providing a workpiece; b) providing a welding tool holding a metal fastener onto the work piece; c) providing a power supply and controller linked with the welding tool; d) plunging the fastener into the locally melted workpiece at the predetermined plunge current; e) energizing a main welding current in the arc locally melting the end of the fastener and forming a weld pool in the workpiece; f) regulating the energizing main current to a predetermined plunge current different than the main welding current forming a weld between the fastener and the work piece; and g) de-energize the current provided by the power supply and withdraw the welding tool from the welded fastener.

In a further aspect there is disclosed a process for drawn arc fastener welding including the steps of: a) providing a workpiece; b) providing a welding tool holding a metal fastener onto the work piece; c) providing a power supply and controller linked with the welding tool; d) energizing a main welding current in the arc locally melting the end of the fastener and forming a weld pool in the workpiece; e) plunging the fastener into the locally melted workpiece at the predetermined plunge current; f) regulating the energizing main current to a predetermined plunge current different than the main welding current forming a weld between the fastener and the work piece; and g) de-energize the current provided by the power supply and withdraw the welding tool from the welded fastener.

### BRIEF DESCRIPTION OF THE DRAWINGS

FIG. 1A-F are flow diagrams of the steps of various embodiments of the process for drawn arc welding;

FIG. 2 is a plot of the time versus the current, voltage and fastener position for a drawn arc welding operation of the prior art;

FIG. 3 is a diagram of a welding system;

FIG. 4 is a plot of the time for the current, voltage, fastener position for a drawn arc welding process having a separate plunge current;

FIG. 5 is a plot of the time for the current, voltage, fastener position for a drawn arc welding process having a separate sloped transition plunge current;

FIG. 6 is a plot of the current, voltage and fastener position as a function of time for a drawn arc welding process having a sawtooth waveform in the main arc;

FIG. 7 is a plot of the current, voltage, fastener position as a function of time for a drawn arc welding process having a square wave main current arc;

FIG. 8 is a plot of the voltage and current as a function of time for a drawn arc welding operation of Example 1;

FIG. 9 is a plot of the voltage and amperage as a function of time for a drawn arc welding operation having a set plunge current of 150 amps, as detailed in Example 1;

FIG. 10 includes diagrams of fasteners attached to a work piece having 150 amp and 100 amp plunge current settings all producing acceptable welds;

FIG. 11 is a plot of the current, and voltage, as a function of time for a drawn arc welding process having a ⅜ inch aluminum stud with a pulsed main arc and a separate plunge current;

FIG. 12 is a diagram of the fasteners welded in the plot of FIG. 11;

FIG. 13 is a diagram of the fasteners welded in the plot of FIG. 11 after a bend test;

FIG. 14 is a plot of the current, and voltage, as a function of time for a drawn arc welding process having a ½ inch aluminum stud with a pulsed main arc and a separate plunge current;

FIG. 15 is a plot of the current, and voltage, as a function of time for a drawn arc welding process having a ½ inch aluminum stud with a pulsed main arc and a separate plunge current;

FIG. 16 is a diagram of the fasteners welded in the plot of FIG. 14;

FIG. 17 is a diagram of the fasteners welded in the plot of FIG. 15.

### DETAILED DESCRIPTION OF THE PREFERRED EMBODIMENTS

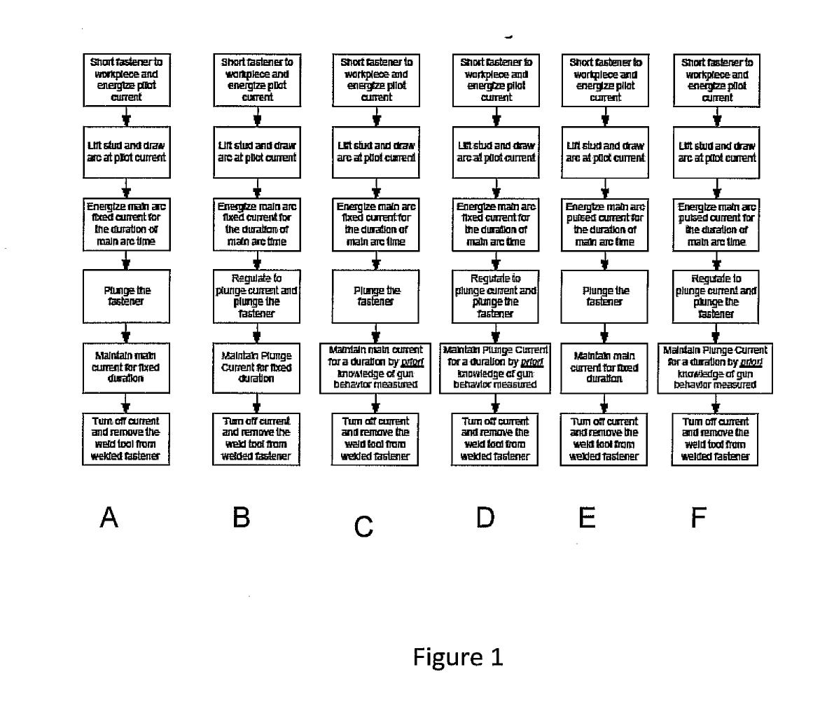

In a first embodiment, shown in FIG. 1B there is disclosed a drawn arc welding process that includes the steps of a) providing a welding device having a metal object or fastener, b) providing a power supply and controller linked with the welding tool, c) providing a work piece, d) energizing a main welding current in the welding tool locally melting the workpiece and forming a weld pool, e) changing the energizing current to a predetermined plunge current, and f) plunging the fastener into the locally melted workpiece at the predetermined plunge current forming a weld between the fastener and the work piece. Additionally, steps a)-f) may be repeated for a new fastener to continue a drawn arc welding process. The drawn arc welding process may include drawn arc or capacitor discharge welding processes. The process may eliminate the significance of the dimension of the timing tip in the total energy input for a CD welding operation. In another aspect, the steps of d), e) and f) may be performed in various orders based upon the desired application. For example a short cycle welding operation may require the plunging step to be started prior to energizing the main arc or prior to lowering the energizing current to produce a desired arc current, plunge time or other parameter required for a specific welding operation.

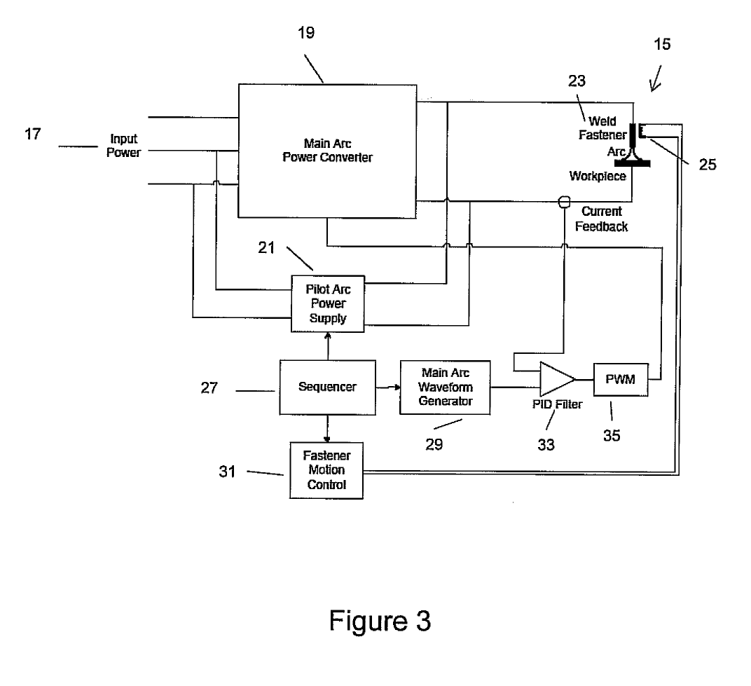

Referring to FIG. 3, there is shown a schematic of a welding system 15 that may be utilized in the various embodiments of the processes described below. The input power 17 may be linked with a main arc power converter 19 and a pilot arc power supply 21 that are both connected to the welding tool 23 having the fastener 25. The pilot arc power supply 21 is linked with a sequencer 27 that is coupled to both a main arc waveform generator 29 and a fastener motion control device 31. The main arc waveform generator 29 is linked with a PID filter 33 that receives a current feedback from the welding circuit. A PWM module 35 is linked with a PID filter 33 and is connected to the main arc power generator 29. The PWM module 35 is a pulse width modulation module that may control a semiconductor switch or switches employed in a switch-mode power supply. A digital control may generate these PWM pulses which drive pulse transformers, which in turn drive the switches. The PID filter or Proportional-Integral-Differential filter 33 provides closed loop control of the welding current. The welding system 15 in one aspect is a digital implementation with software in contrast to the analog prior art. The sequencer 27 having software logic commands the current control and the fastener motion control or the timing control and coordination of both current and fastener lift and plunge.

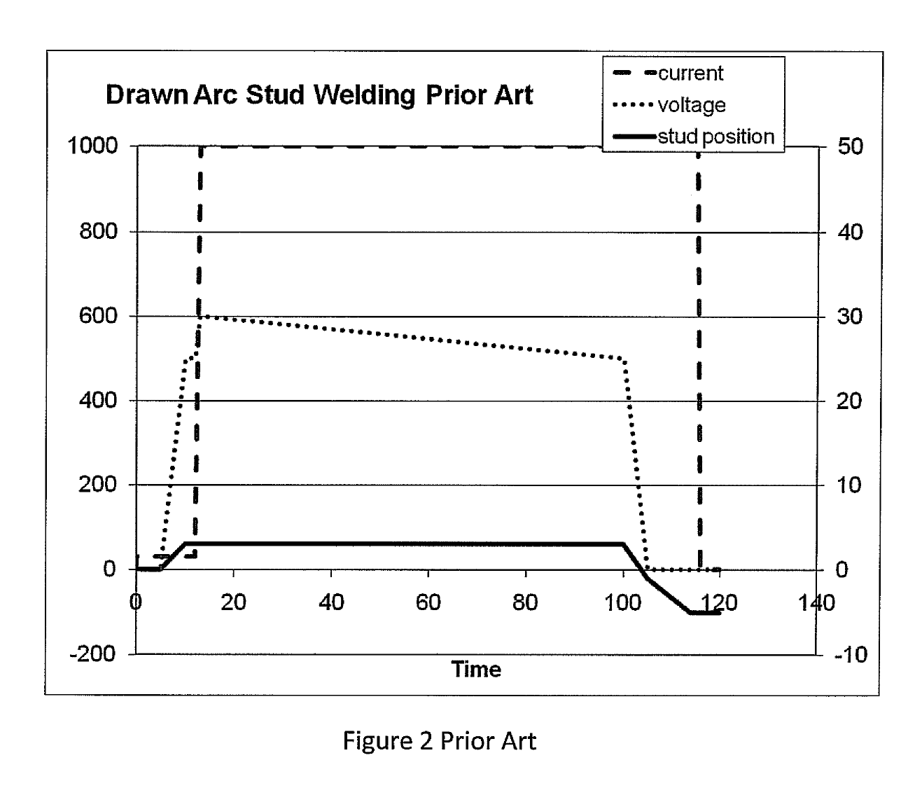

Referring to FIGS. 1A and 2, there is shown a diagram of the current, voltage and fastener position as a function of time for a prior art welding operation. As can be seen in FIG. 2, the current follows a boxlike structure on the graph wherein it starts at a low 20A pilot arc and then rises to a constant level of 1000 A and maintains it as the welding operation progresses and then is commanded to go to zero when the main current is switched off Actual current decays to zero depending on the circuit inductance. As can be seen in the figure, the main current is maintained until the fastener has moved from a lifted position to its fully plunged position 5 mm below the original zero position. Additionally, it can be seen that the current in the depicted graph is constant around 1000 amps until the fastener welding operation is completed.

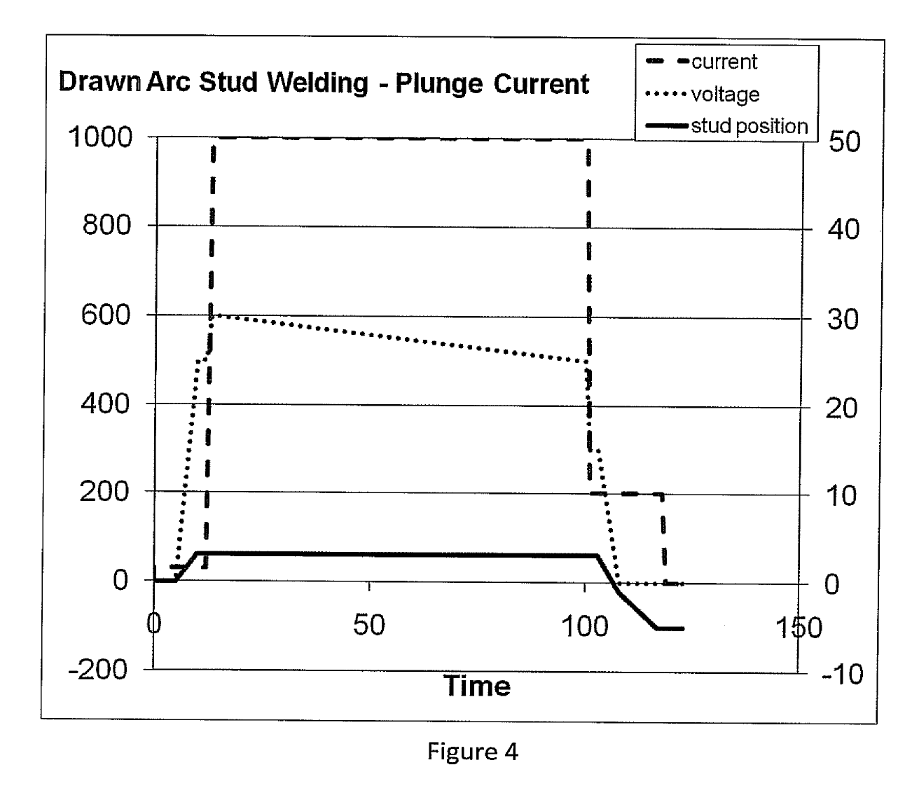

Referring to FIGS. 1B and 4, there is shown a diagram of the current, voltage, and fastener position of the drawn arc welding process of a first embodiment. As can be seen in the figure, the current follows a similar pattern initially to that of FIG. 1 rising to approximately 1000 amps after the pilot arc and is maintained constant until a set point in time wherein the main welding current is lowered to a predetermined plunge current of approximately 200 amps shown in the figure, although other currents that are lower than the main current may be utilized and may be maintained constant over the time of the plunge operation. As can be seen in the figure, the plunge current is reached before the start of the movement of the fastener from its lifted position to its fully plunged position. Additionally, the plunge current is set at an amount lower than that of the initial main current. In one aspect, the predetermined plunge current is set to an amount sufficient to maintain a desired temperature of the weld pool. In another aspect, weld spatter from the weld pool during the plunging of the fastener is minimized as the plunge current is lower than the main arc current thereby lowering spatter or splatter associated with the plunge, as will be discussed in more detail below.

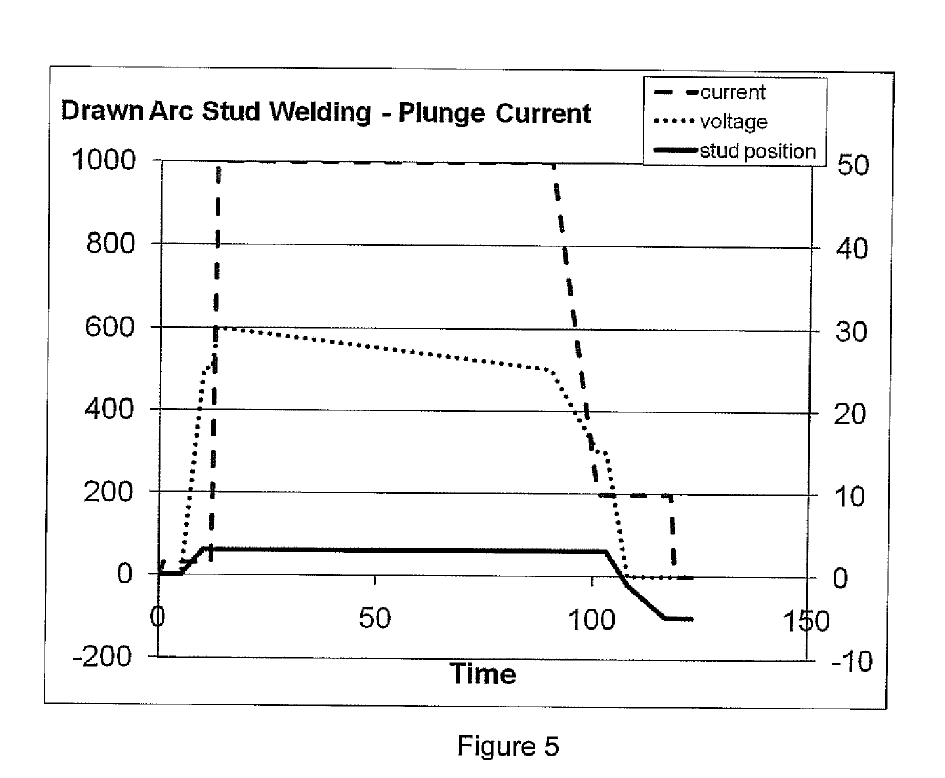

Referring to FIG. 5, there is shown an alternate embodiment of FIG. 4. The alternate embodiment includes a slope in the transition between the main current and the plunge current to release the arc force gradually. Arc plasma force applied to the weld pool surface is approximately proportional to the arc current. If a sudden removal of the current or arc pressure occurs the depressed weld pool surface may bounce back or oscillate and cause unpredictable shorts to the end of the fastener and resultant spatter. The rebound effectively increases the plunge speed of the fastener, because the arc gap is being closed from both the fastener plunge and the weld pool rebound. The sloped transition may be utilized as plunge dampening, similar to a shock absorber mounted in the weld tool to slow down fastener motion in order to minimize the splash. Although FIG. 5 shows a straight line transition between the main current and the plunge current other forms such as parabolic or stair-cased transitions formed either intentionally or naturally from the circuit inductance may be utilized.

The welding tool of the process of the present invention includes cables linking the welding tool to the power supply. The cables include an inductance that causes heating of the cables during the welding operation. In one aspect, the step of lowering the energizing current reduces heating of the cables providing extended welding operation time. In a drawn arc welding operation, cables and connectors connecting the welding tool to the power supply may overheat and melt or becoming loose eventually requiring down time of a welding operation to allow the cables and connectors to be repaired to continue production. Therefore, the step of lowering the energizing current increases the longevity of the welding tool and provides for a more continuous welding operation and lower the maintenance costs. Additionally, as the welding current is lowered during the plunging operation the overall energy consumption of the welding operation is reduced in comparison to a welding operation having only a single energizing current, as shown in FIG. 2. In one aspect, the power supply of the process may be a switch mode power supply and may include inverters and buck converters and controlled by microprocessors.

The process of the present invention also provides a reliable process for welding tools that may change properties over a service life of the welding tool. For example, a welding gun may include a chuck or chuck adaptor having a piston that may have slightly different travel during its service life. Additionally, various components of the welding tool including springs and solenoids may change properties during the service life of the tool. Utilizing the process of the present invention, welding tools having changing properties resulting in different plunge speeds and different operation of the welding tool may be accommodated as the plunge current is maintained during the plunging operation resulting in a contact with the weld pool at a given current independent of the main arc current for welding. In this manner, varying decays of the current and timing of the movement of the plunging of a fastener in the prior art are avoided as the weld current or plunge current is maintained steady during the plunging operation. In addition, weld spatter is minimized as the current when the fastener first touches (or bridges) the molten pool surface is lower than the main arc current to form the weld pool such that the high current density on the liquid bridge and electromagnetic pinch effect that squeezes molten metal from the weld pool is reduced. In one aspect, the fastener utilized in the process may include a flux ball positioned at an end of the fastener and a ferrule positioned about the end of the fastener. In the alternative, gas shielding may be employed instead of ferrule or flux ball.

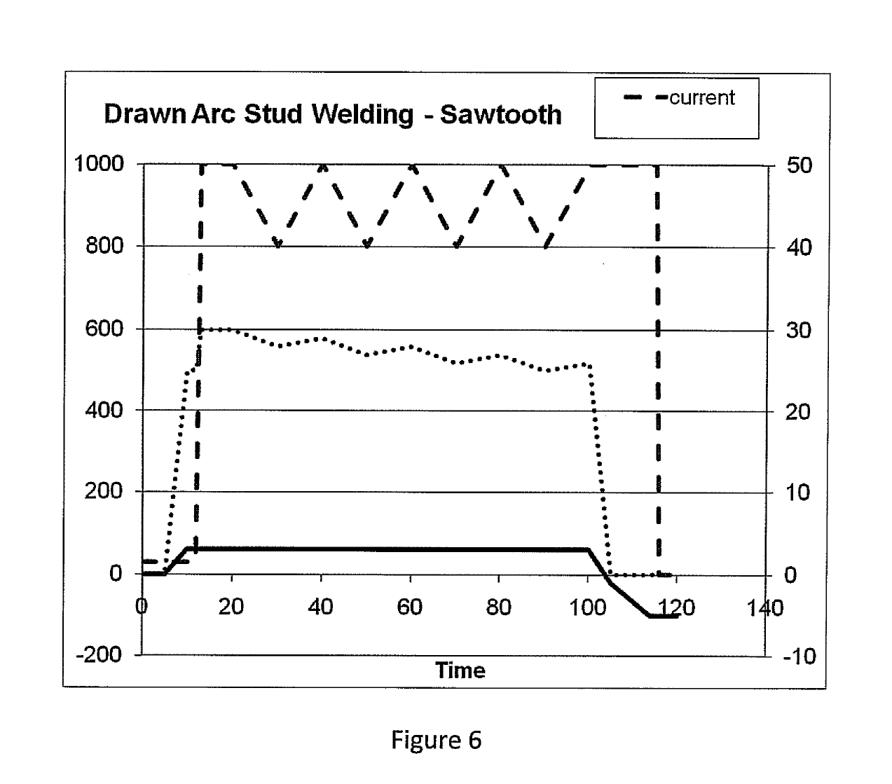

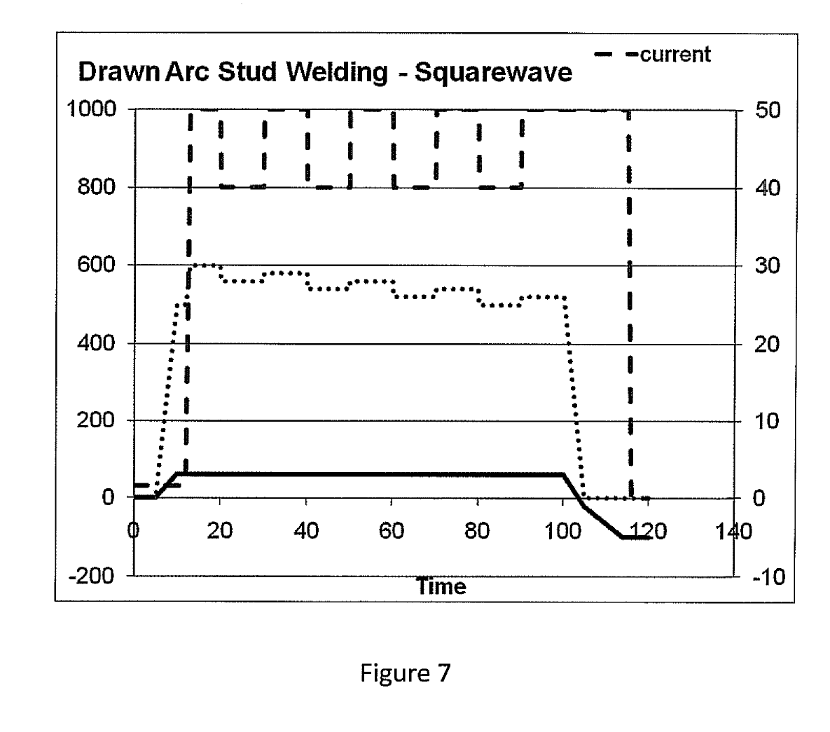

Referring to FIGS. 1C, 6 and 7, there are shown diagrams relating to an alternative embodiment of step d) of the process. The second embodiment of the process discloses a drawn arc welding process where the welding current has a programmed pulsed waveform having a repeatable pattern having at least two levels. In one aspect, the waveform may be selected from sinusoidal, sawtooth and square waveforms. As can be seen in FIG. 6, the sawtooth profile displays a current that raises and lowers between 1000 and 800 amps over time to form a sawtooth profile. Similarly in FIG. 7, there is shown a square tooth profile in which the weld current alternates between 1000 and 800 amps as a function of time for a square tooth profile. The programmed waveform has been found to stiffen a weld arc reducing arc blow from external magnetic field, poor grounding practice or welding at the edge or work piece. Additionally, the programmed waveform provides an increased efficiency in penetrating surface contamination such as scale, grease or other contaminations disposed on a workpiece. Further, the programmed waveform increases the directional control of the arc and uniform melting of fastener when in an out-of-position welding operation. Typically, the drawn arc welding operation may be done in a down-hand (or flat) position where the fastener is in a vertical position with the welding tool positioned above it such that the fastener is plunged vertically into a molten pool formed on a workpiece. However, often it is desirable to have a welding operation in an overhead or horizontal position which may be referred to as an out-of-position welding. Additionally, the programmed waveform reduces the total heat input into the fastener and the work piece as the arc is energized such that back side marking of a workpiece is reduced. A given fastener diameter requires a corresponding current level to create sufficiently large arc column to melt the entire area of the fastener end and the opposing base metal workpiece. The size of the arc column increases with the current level. Pulse waveform containing current peaks forming transitory enlarged arc column that melts the area of the fastener end and work piece while keeping the average current or heat input low. Additionally, heat generated in the workpiece is lessened thereby increasing applications of the welding process on heat-sensitive applications such as thin gauge material, heat-sensitive materials such as aluminum and parts with painted surface in the back that can not tolerate backside heat marks.

The pulse waveform may have benefits and makes the process more robust having a larger operating window in tolerating current and lift variations. The process outlined above pro-actively commands the programmed current or commanded current to create beneficial ripples in the weld current.

There is also disclosed a second process embodiment as shown in FIGS. 1C, E and F of an arc welding process that includes the steps of a) providing a welding tool having a metal object or fastener, b) providing a power supply and controller linked with the welding tool, c) providing a work piece, d) calibrating the welding tool including: plunging the fastener toward the work piece and starting a timer contacting the fastener to the work piece shorting a sensing voltage and stopping the timer, and recording the time between the start and the stop of the timer. Step d) can be accomplished with or without energizing the main welding current, but with main current (live arc) the calibration is more precise. In step e) the main welding current is energized in the welding tool for a time defined by a preprogrammed value locally melting the workpiece and forming a weld pool. In step f) the fastener is physically plunged into the locally melted workpiece forming a weld between the fastener and the work piece. The plunge step is performed at a time determined by the recorded time in step d) such that the preprogrammed value of the time of the main weld current is maintained. Due to the delay or dead time of commanding the plunge (de-energizing the gun lift coil power supply) to the actual initial fastener plunge movement, it is sometimes necessary to command plunge during pilot arc period before the start of main current to obtain short main arc time. In other words, it is possible to command plunge (de-energize lift coil) before commanding main welding current to achieve desired main current time based on the measurement result in Step d). Additionally, steps a)-c) and e)-f) may be then repeated for multiple welds in a welding operation. Additionally the main current may be lowered to a plunge current as described above in the first embodiment. As can be seen from the above description, the calibration of the welding tool defines the time for the fastener to be plunged into a molten weld pool. This time is recorded and then utilized by the controller such that the plunging operation is performed to maintain the preprogrammed value of the time of the main weld current. In this manner, the timing between the energizing of the main weld arc and the plunging of the fastener into the work piece is adaptive to the actual weld tool (gun or head) behavior connected to the power supply. Calibration of the live arc can be also used in the calibration step described above. Live arc has the benefit of more accurate drop time measurement considering the weld pool depression below the workpiece surface which increases the drop time; and the melting of stud end making the stud longer which reduces the drop time (especially with aluminum). However, caution and discretion may be exercised in using live arc, because accidental shorts can happen before the fastener is plunged into the weld pool causing false detection and undervalued plunge time measurement. Live arc measurement lower than the measurement value without arc will be discarded as an erroneous measurement and not used for the next weld. False short detection can happen also when welding in through deck applications where the gap can exist between the deck and the I-beam. The short to the upper deck will stop the plunge timer, resulting in undervalue of plunge time. Live arc calibration for the next weld may not be used for welding in through deck applications.

In one aspect, the calibration step of step d) may be repeated when a different welding tool is provided. In this manner, when one welding tool is switched during a welding operation to another, the calibration step is activated with the very first trigger pull after a new welding tool is recognized by the breaking and re-making of gun coil circuit, such that variations between welding tools may be accounted for. Additionally, the calibration step d) may be logged and trended after a predetermined number of welding operations to reflect changes in the welding tool over the service life of the welding tool and serve as indication to alert necessity for gun service.

In another aspect, the calibration step d) is inherent of each fastener welding with live arc. The timer records the actual plunge time of the current weld, and use it as a basis for the programmed plunge time for the next weld. This accounts for the extra plunge time when the fastener moves below the workpiece while the molten weld pool is depressed by the arc force. This calibration with live arc of previous weld provides an accurate calibration.

As with the previous described embodiment, the power supply may be a switch mode power supply selected from inverters and buck converters. Additionally, the fastener may include a flux ball positioned at an end of the fastener and a ferrule positioned about the end of the fastener. Alternatively, gas shielding may be employed instead of a ferrule or flux ball.

Additionally, in one aspect, the current may transition from main arc to plunge current level before the fastener is scheduled to short circuit into the work piece based on the prior knowledge of the stud drop time. For example 3 ms before the short the current may transition for insurance that the actual drop time is longer than the calibrated value which is based on a prior known value. This action may compensate for the cable inductance that adds ramp time for an actual current to change.

### EXAMPLES

### Example 1

In this example, H4L ⅝ inch fasteners were welded to standard base material using a Nelson N1500i power supply. The waveforms of the arc voltage and welding current were recorded using a data acquisition interface and software suite. The fastener was an H4L ⅝×2 11/16 inch fastener. The base material was mild steel. A Nelson NS20 heavy duty gun with a 9 foot 4/0 AWG cable and 25 foot 4/0 AWG weld cable and 25 foot 4/0 AWG ground cable were utilized. The main arc welding parameters include a current of 1100 amps for a time of 625 milliseconds with a lift height of 3/32 of an inch and a plunge height of 3/16 of an inch.

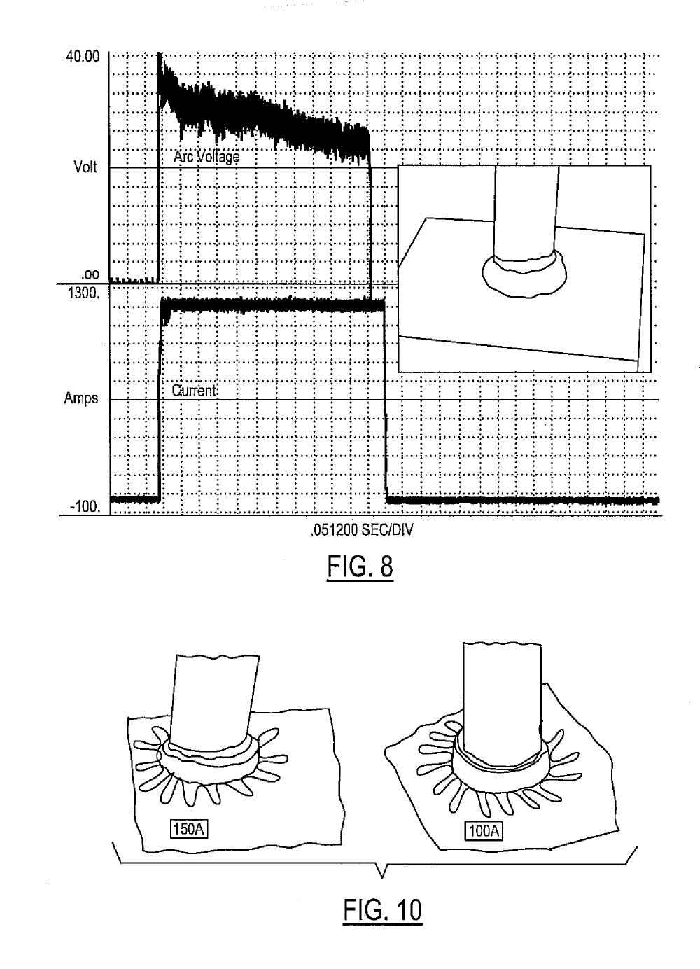

Referring to FIG. 8, there is shown a first welding operation having the above parameters including no separate plunge current. As can be seen in the figure, the weld current follows a boxlike pattern in which the current is energized and maintained for a period of time at a constant level and then drops severely at the end of the plunge cycle of the welding operation. As can be seen in the figure, the arc voltage collapses about 50 ms before the current is reduced to zero, so extra energy was delivered at 1100 A for 50 ms after the fastener has already plunged into the weld pool. The weld formed includes a significant amount of spatter formed around the fastener in relation to the fillet formed between the work piece and fastener.

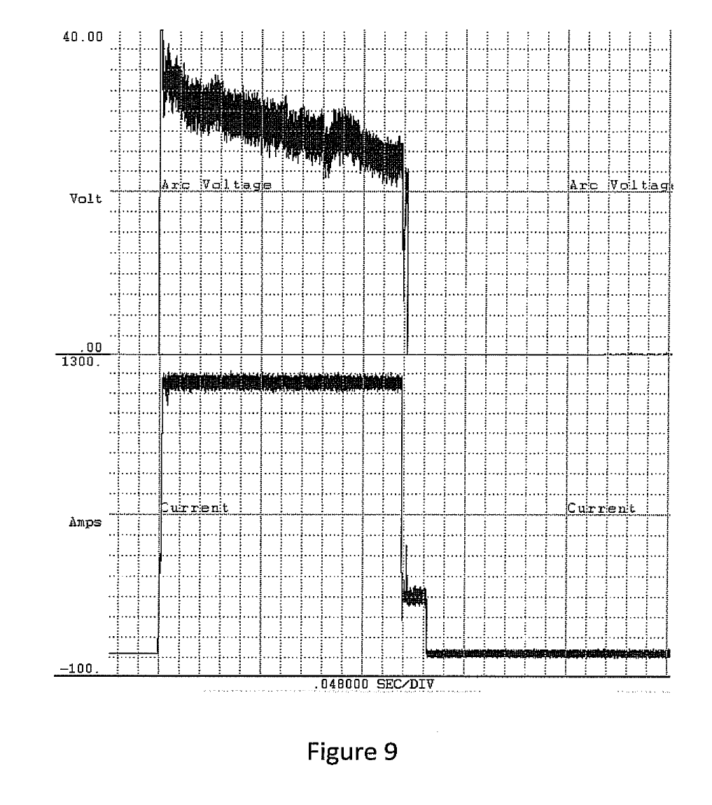

Referring to FIG. 9, there is shown a waveform of the current and voltage of a welding operation having a plunge welding current setting of 150 amps. As can be seen from the figure, the weld current is maintained at approximately 1100 amps and is then lowered to approximately 150 amps detected during the plunging operation. As can be seen in FIG. 10, the various plunge current settings of 100 and 150 amps all yielded acceptable welds.

### Example 2

In this example, HBA aluminum ⅜ inch fasteners were welded to standard base material using a Nelson N1500i power supply. The waveforms of the arc voltage and welding current were recorded using a data acquisition interface and software suite. The fastener was an HBA ⅜×1-¾ inch fastener. The base material was a 5083 material ⅛ inch thick. A Nelson NS40 gun with a 9 foot 4/0 AWG cable and 25 foot 4/0 AWG weld cable and 25 foot 4/0 AWG ground cable were utilized. The main arc welding parameters include a lift height of 0.120 to ⅜ of an inch and a plunge height of 3/16 of an inch.

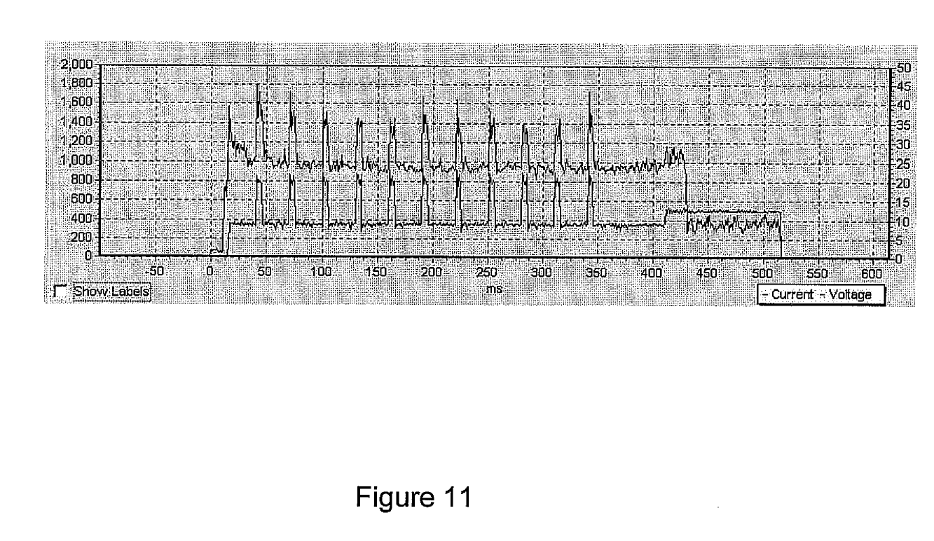

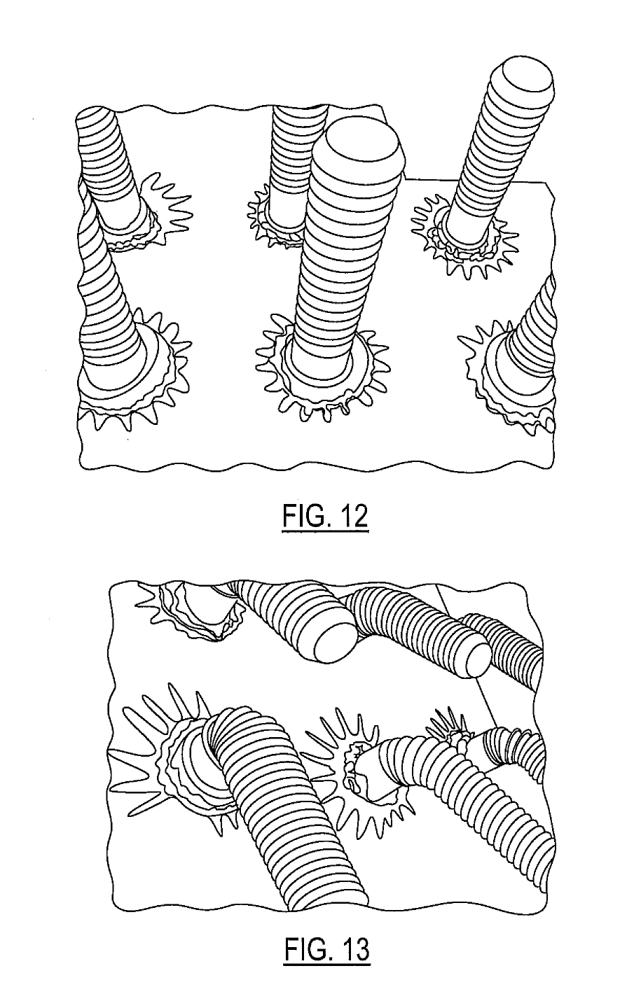

Referring to FIG. 11, there is shown a waveform of the current and voltage of a welding operation having a main arc current that is pulsed and plunge welding current having a different setting. As can be seen from the figure, the weld current is varied from about 400 to 800 amps and is then changed to approximately 500 amps commanded during the plunging operation. As can be seen in FIGS. 12 and 13, the various fasteners welded yielded acceptable welds that passed a bend test in which the stud is bent off its axis at least 15 degrees.

### Example 3

In this example, HBA aluminum ½ inch fasteners were welded to standard base material using a Nelson N1500i power supply. The waveforms of the arc voltage and welding current were recorded using a data acquisition interface and software suite. The fastener was an HBA ½×2 inch fastener or a TBA ½×⅞ inch fastener. The base material was a 6061T6 material ¼ inch thick. A Nelson NS40 gun with a 9 foot 4/0 AWG cable and 25 foot 4/0 AWG weld cable and 25 foot 4/0 AWG ground cable were utilized. The main arc welding parameters include a lift height of 0.120 to ⅜ of an inch and a plunge height of 3/16 of an inch.

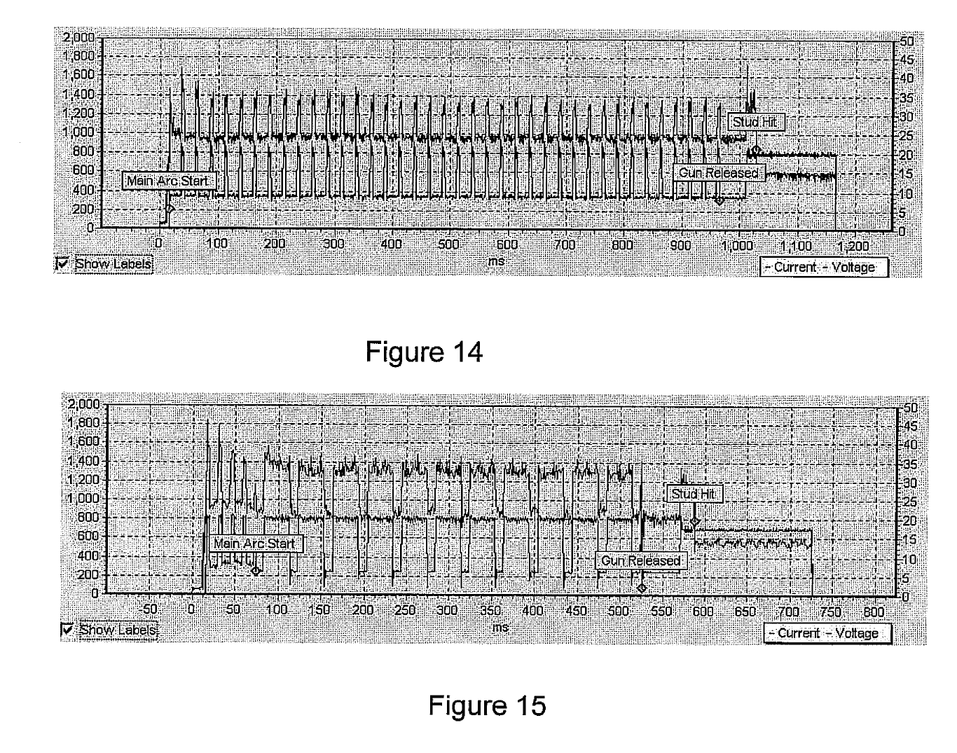

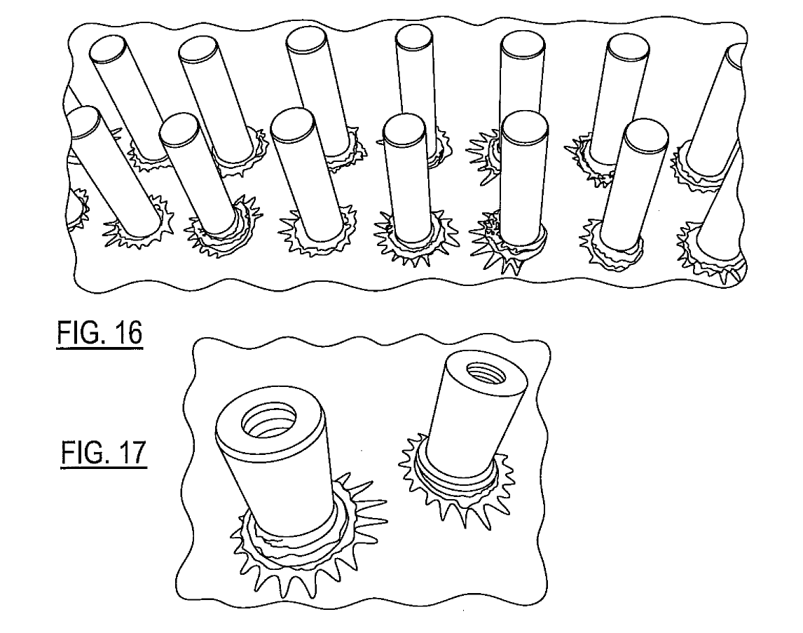

Referring to FIGS. 14 and 15, there are shown waveforms of the current and voltage of a welding operation having a main arc current that is pulsed and a plunge welding current having a different setting. As can be seen in FIG. 14, the weld current is varied from about 400 to 800 amps and is then changed to approximately 600 amps commanded during the plunging operation. As can be seen in FIG. 16, the various fasteners welded yielded acceptable welds.

As can be seen in FIG. 15, the weld current is varied from about 200 to 800 amps and is then changed to approximately 700 amps detected during the plunging operation. As can be seen in FIG. 17, the various fasteners welded yielded acceptable welds.

1. A drawn arc welding process comprising the steps of
a) providing a workpiece;
b) providing a welding tool holding a metal object onto the work piece;
c) providing a power supply and controller linked with the welding tool;
d) energizing a main welding current in the arc locally melting the end of the fastener and forming a weld pool in the workpiece;
e) regulating the energizing main current to a predetermined plunge current different than the main welding current;
f) plunging the fastener into the locally melted workpiece at the predetermined plunge current forming a weld between the fastener and the work piece; and
g) de-energize the current provided by the power supply and withdraw the welding tool from the welded fastener.

2. The drawn arc welding process of claim 1 wherein the metal object is selected from: a fastener, a metal stud, a metal nut, a metal shaft and a metal bracket.

3. The drawn arc welding process of claim 1 wherein a transition between the main current to the plunge current includes a sloped current decay.

4. The drawn arc welding process of claim 1 wherein a transition between the main current to the plunge current includes a sloped decay having a cycle or curved profile.

5. The drawn arc welding process of claim 1 wherein the plunge current is constant.

6. The drawn arc welding process of claim 1 wherein the predetermined plunge current is set to an amount sufficient to maintain a desired temperature of the weld pool.

7. The drawn arc welding process of claim 1 wherein spatter from the weld pool is minimized.

8. The drawn arc welding process of claim 1 wherein the welding tool includes cables and connectors linking the welding tool to the power supply and wherein the cables include resistance causing heating of the cables.

9. The drawn arc welding process of claim 8 wherein the step of lowering the energizing current lowers heating of the cables providing extended welding operation time.

10. The drawn arc welding process of claim 1 wherein the overall waste energy of the welding operation is reduced in comparison to a welding operation having only an energizing current.

11. The drawn arc welding process of claim 1 wherein the power supply is a switch mode power supply selected from inverters and buck converters.

12. The drawn arc welding process of claim 1 wherein the plunge current is set reducing the need to adjust the time of a welding current dependant on a weld circuit inductance, fastener plunge speed and a synchronization of the current amount and fastener movement.

13. The drawn arc welding process of claim 2 wherein the fastener includes a flux ball positioned at an end of the fastener and a ferrule positioned about the end of the fastener.

14. The drawn arc welding process of claim 1 wherein gas shielding is used to protect oxidization of a weld zone.

15. A drawn arc welding process comprising the steps of:
a) providing a welding tool having a fastener;
b) providing a power supply and controller linked with the welding tool;
c) providing a workpiece;
d) measuring the actual plunge time of the welding tool including: lifting and plunging the fastener toward the work piece and starting a timer; detecting the contact of the fastener and the workpiece and stopping the timer; and recording the time between the start and stop of the timer;
e) lifting the fastener and energizing a pilot arc, and energizing a main welding current in the welding tool for a time defined by a preprogrammed value locally melting the end of the fastener and the workpiece and forming a weld pool; and
f) plunging the fastener into the locally melted workpiece and controlling the power supply current to a plunge current level, and maintain that current for a time determined by the timer value in step d) plus additional time to ensure the contact of the fastener and the workpiece occurs before the plunge current is turned off;
g) turn off the plunge current and withdraw the welding tool from the welded fastener.

16. The drawn arc fastener welding process of claim 15 wherein step d) uses an external power supply to measure the contact of the fastener and the workpiece without welding.

17. The drawn arc fastener welding process of claim 15 wherein step d) is actual welding process with a drawn arc and the collapse of arc voltage measurement is used to detect the contact of the fastener and the work piece and wherein each weld measures the actual plunge time to be used for the next weld after validation.

18. The drawn arc welding process of claim 15 wherein step d) is repeated when the controller detects a disconnect and reconnect of the welding tool.

19. The drawn arc welding process of claim 15 wherein step d) is repeated after a predetermined number of welding operations and an average is taken for the determination of relative timing on commanding main arc current and commanding plunge

20. The drawn arc welding process of claim 15 wherein the plunge current in step f) is the same as the main arc current.

21. The drawn arc welding process of claim 15 wherein the plunge current in step f) is different than the main arc current.

22. The drawn arc welding process of claim 15 wherein the power supply is a switch mode power supply selected from inverters and buck converters.

23. The drawn arc welding process of claim 15 wherein the fastener is selected from:
a stud including a flux ball positioned at an end of the stud and a ferrule positioned about the end of the stud, a metal stud, an aluminum stud, a metal nut, and a metal bracket.

24. The drawn arc welding process of claim 15 wherein gas shielding is used to protect oxidization of a weld zone

25. The drawn arc process of claim 15 including the step of changing the energizing main current to a predetermined plunge current different than the main welding current.

26. The drawn arc process of claim 15 wherein step d) uses an external power supply to measure the contact of the fastener and the work piece without welding.

27. The drawn arc process of claim 15 wherein step d) is actual welding process with a drawn arc and the collapse of are voltage measurement is used to detect the contact of the fastener and the work piece and wherein each weld measures the actual plunge time to be used for the next weld after validation.

28. The drawn arc welding process of claim 1 wherein the main arc includes a waveform selected from sinusoidal saw tooth, trapezoidal, and square waveforms.

29. The drawn arc welding process of claim 15 wherein the current may transition from main arc to plunge current level before the fastener is scheduled to short circuit into the work piece.

30. A drawn arc welding process comprising the steps of:
a) providing a workpiece;
b) providing a welding tool holding a metal fastener onto the work piece;
c) providing a power supply and controller linked with the welding tool;
d) plunging the fastener into the locally melted workpiece at the predetermined plunge current;
e) energizing a main welding current in the arc locally melting the end of the fastener and forming a weld pool in the workpiece;
f) regulating the energizing main current to a predetermined plunge current different than the main welding current forming a weld between the fastener and the work piece; and
g) de-energize the current provided by the power supply and withdraw the welding tool from the welded fastener.

31. A drawn arc welding process comprising the steps of
a) providing a workpiece;
b) providing a welding tool holding a metal fastener onto the work piece;
c) providing a power supply and controller linked with the welding tool;
d) energizing a main welding current in the arc locally melting the end of the fastener and forming a weld pool in the workpiece;
e) plunging the fastener into the locally melted workpiece at the predetermined plunge current;
f) regulating the energizing main current to a predetermined plunge current different than the main welding current forming a weld between the fastener and the work piece; and
g) de-energize the current provided by the power supply and withdraw the welding tool from the welded fastener.
